(19) United States
(12) Patent Application Publication
(10) Pub. No.: US 2025/0239733 A1
(43) Pub. Date: Jul. 24, 2025

(54) SECONDARY BATTERY

(71) Applicant: SK ON CO., LTD., Seoul (KR)

(72) Inventors: Hae Ryong JEON, Daejeon (KR); Soo Min PARK, Daejeon (KR); Hyung Ju PAIK, Daejeon (KR); Hoemin CHEONG, Daejeon (KR); Won Tae HEO, Daejeon (KR); Seung Pil LEE, Daejeon (KR)

(21) Appl. No.: 18/938,178

(22) Filed: Nov. 5, 2024

(30) Foreign Application Priority Data
Jan. 22, 2024 (KR) 10-2024-0009712

(51) Int. Cl. H01M 50/474; H01M 10/42; H01M 50/103; H01M 50/15; H01M 50/477; H01M 50/627

(52) U.S. Cl. CPC H01M 50/474; H01M 10/4235; H01M 50/103; H01M 50/15; H01M 50/477; H01M 50/627

(57) ABSTRACT

A secondary battery includes an electrode assembly including a positive electrode, a negative electrode, and a separator separating the positive electrode and the negative electrode from each other, a battery case including a space accommodating the electrode assembly, and at least one opening, a cap plate coupled to the battery case to close the at least one opening and including an electrolyte inlet through which an electrolyte is injected, and an elastic support disposed at least partially in close contact with a lower edge of the electrode assembly and mounted on an inner bottom surface of the battery case to elastically support the electrode assembly in a vertical direction.

### CROSS-REFERENCE TO RELATED APPLICATION(S)

This patent document claims the priority and benefits of Korean Patent Application No. 10-2024-0009712 filed on Jan. 22, 2024, the disclosure of which is incorporated herein by reference in its entirety.

### TECHNICAL FIELD

The disclosure and implementations disclosed in this patent document generally relate to a secondary battery that may be recharged and discharged.

### BACKGROUND

Secondary batteries are energy storage devices that can be repeatedly recharged and discharged, and are widely used in various electronic devices from small devices, such as mobile phones, laptops, and tablets to large devices, such as vehicles and aircraft. Recently, the use of secondary batteries as a power source for vehicles has been growing rapidly.

Secondary batteries may be classified into different types such as lead-acid batteries, nickel-cadmium batteries, nickel-hydrogen batteries, lithium-ion batteries, etc. based on the electrode materials used. The appropriate type can be selected according to factors such as design capacity, usage environment, etc. Among the secondary batteries, lithium-ion batteries, which offer relatively high voltage and capacity compared to other secondary batteries, are widely used in fields that require high-density energy storage, such as battery packs for electric vehicles.

### SUMMARY

The disclosed technology may be implemented in some embodiments to provide a secondary battery having improved stability of an electrode assembly against external impact loads that may occur while a vehicle is in motion.

The disclosed technology may also be implemented in some embodiments to provide a secondary battery having improved compression and bending stability of a battery case, enhancing its resistance to external impact loads.

The disclosed technology may also be implemented in some embodiments to provide a secondary battery having improved stability for even flow of an electrolyte.

The secondary battery implemented based on some embodiments of the disclosed technology may be widely use in green technology fields, such as electric vehicles, battery charging stations, solar power generation systems and wind power generation systems utilizing batteries. In addition, the secondary battery implemented based on some embodiments of the disclosed technology may be used in eco-friendly electric vehicles and hybrid vehicles, helping to combat climate change by reducing air pollution and greenhouse gas emissions.

In some embodiments of the disclosed technology, a secondary battery includes: an electrode assembly including a positive electrode, a negative electrode, and a separator that separates the positive electrode and the negative electrode from each other; a battery case including an accommodating space for accommodating the electrode assembly and at least one opening; a cap plate coupled to the battery case to close the at least one opening and including an electrolyte inlet configured to inject an electrolyte; and an elastic support disposed at least partially in close contact with a lower edge of the electrode assembly and mounted on an inner bottom surface of the battery case to elastically support the electrode assembly in a vertical direction.

In an embodiment, the battery case includes an uneven portion disposed on the inner bottom surface of the battery case to increase transverse rigidity of the inner bottom surface, helping the electrolyte flow evenly or smoothly. In an embodiment, the uneven portion includes a concave portion configured to evenly distribute the electrolyte in a transverse direction of the inner bottom surface, when the electrolyte starts to rise on the inner bottom surface. the concave portion is configured to allow debris (e.g., arc debris) generated from the electrode assembly to accumulate without coming into contact with the inner bottom surface of the electrode assembly, when the debris falls downward.

In an embodiment, the elastic support includes a bottom plate, and the bottom plate includes: protrusions and recesses repeatedly formed to be spaced from each other alternately in a facing manner on two longer sides facing each other and two shorter sides facing each other; and inlet holes through which the electrolyte flows. For example, the bottom plate includes protrusions and recesses alternately and repeatedly arranged along two opposing longer sides and two opposing shorter sides of the bottom plate, such that the protrusions and recesses on the opposing longer sides face each other and the protrusions and recesses on the opposing shorter sides face each other. In addition, the elastic support may further include a shorter upward side elastic support piece formed upward and integrally connected with the protrusions formed on the two opposing longer sides of the bottom plate (e.g., two longer sides of the bottom plate facing each other), and the shorter upward side elastic support piece may include a close contact portion vertically connected to the protrusions, an extension portion inclined upward from the close contact portion, and a finishing portion vertically connected to the extension portion. The elastic support may further include an shorter upward side elastic support piece formed upwardly and integrally connected with the protrusions formed on the two opposing shorter sides of the bottom plate (e.g., two shorter sides of the bottom plate facing each other), and the shorter upward side elastic support piece may include a close contact portion vertically connected to the protrusions, an extension portion inclined upward from the close contact portion, and a finishing portion vertically connected to the extension portion. In addition, the elastic support may further include a longer downward side elastic support piece formed downward and integrally connected with recesses formed on the two opposing longer sides of the bottom plate (e.g., two longer sides of the bottom plate facing each other), and the shorter downward side elastic support piece may include an extension portion inclined downward from the recesses and a support portion connected horizontally to the extension portion. In addition, the elastic support may further include a longer downward side elastic support piece formed downward to be integrally connected with recesses formed on the two opposing shorter sides of the bottom plate (e.g., two shorter sides of the bottom plate facing each other), and the shorter downward side elastic support piece may include an extension portion inclined downward from the recesses and a support portion connected horizontally to the extension portion.

### BRIEF DESCRIPTION OF DRAWINGS

Certain aspects, features, and advantages of the disclosed technology are illustrated by the following detailed description with reference to the accompanying drawings.

FIG. 1 is a perspective view illustrating an example of a secondary battery.

FIG. 2 is a cross-sectional view taken along line A-A′ of FIG. 1.

FIG. 3 is a perspective view illustrating the bottom retainer of FIG. 1.

FIG. 4 is a cross-sectional view taken along line B-B′ of FIG. 3.

FIG. 5 is an exploded perspective view of a secondary battery based on an embodiment.

FIG. 6 is a partially enlarged view of a battery case of FIG. 5.

FIG. 7 is an enlarged perspective view of an elastic support of FIG. 5.

FIG. 8 is an enlarged perspective view of the elastic support of FIG. 5 based on another embodiment.

FIG. 9 is an enlarged perspective view of the elastic support of FIG. 5 based on another embodiment.

FIG. 10 is an enlarged perspective view of the elastic support of FIG. 5 based on another embodiment.

FIGS. 11A and 11B are views illustrating an operation of a battery case, an electrode assembly, and the elastic support of FIG. 5.

### DETAILED DESCRIPTION

Hereinafter, a secondary battery with improved safety based on some embodiments will be described with reference to the accompanying drawings.

A secondary battery, such as a lithium-ion battery, includes a positive electrode (cathode), a negative electrode (anode), a separator, and an electrolyte. The positive and negative electrodes are arranged with a separator formed of an insulating material between the positive and negative electrodes, allowing ions to migrate through the electrolyte during charging or discharging.

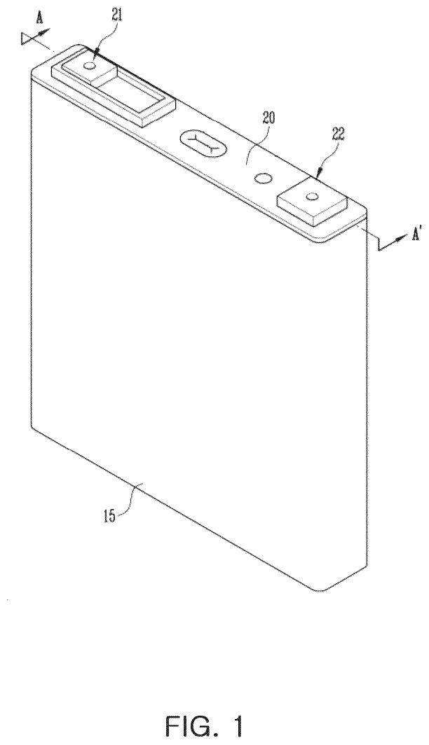

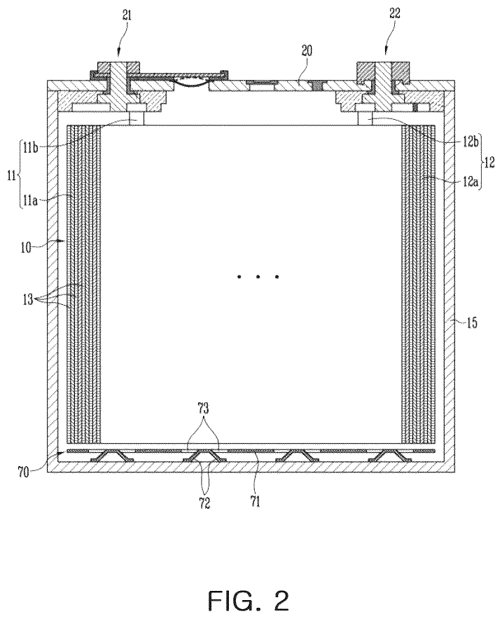

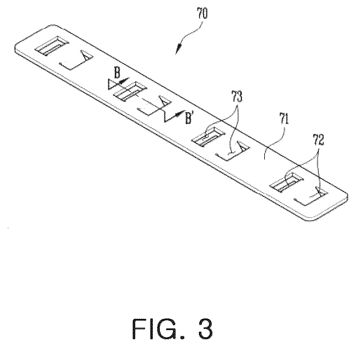

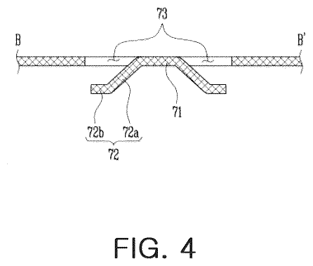

As shown in FIGS. 1 to 4, an example of a secondary battery may include an electrode assembly 10, a case 15, a cap plate 20, and a bottom retainer 70.

The electrode assembly 10 includes a first electrode 11, a second electrode 12, and a separator 13 interposed between the first electrode 11 and the second electrode 12.

The case 15 has an opening formed in the top thereof and a space provided therein to accommodate the electrode assembly 10.

The cap plate 20 seals the opening of the case 15 and is connected to the first electrode 11 and the second electrode 12. A first electrode terminal 21 and a second electrode terminal 22 are formed to be spaced apart from each other in a first direction.

The bottom retainer 70 is formed of an insulating material and is located on an inner bottom surface of the case 15. The bottom retainer 70 includes a support portion 71 supporting the electrode assembly 10 and at least one contact portion 72 in contact with the bottom surface of the case 15.

The support portion 71 is formed to have a flat plate shape, and at least a portion of the edge of the support portion 71 has a wave pattern shape and is formed to be spaced apart from the electrode assembly 10.

In addition, the support portion 71 is formed with a closed hole 73 in a position spaced apart from the edge, and at least a portion of the hole 73 edge has a wave pattern shape.

Contact portions 72 are positioned on either side of the support portion 71 in the first direction. Each of adjacent contact portions 72 is inclined away from each other in the first direction, as it extends toward the bottom surface of the case 15.

In addition, the contact portion 72 includes an inclined portion 72a that extends at an angle from the support portion 71 toward the bottom surface of the case 15, and a horizontal portion 72b at the end portion of the inclined portion 72a that extends parallel to the bottom surface of the case 15. It is formed to extend from one region of a lower surface of the support portion 71 toward the bottom surface of the case 15.

Two inclined portions 72a are arranged side by side, each angled downward and away from each other.

The support portion 71 and the contact portion 72 are arranged alternately, creating an embossed pattern in the vertical cross-section of the bottom retainer 70 along a longer side of the case 15.

In the secondary battery discussed above, although the bottom surface of the electrode assembly 10 accommodated in the case 15 is elastically supported by the bottom retainer 70, the sides thereof remain unsupported. This may result in reduced stability against external impact loads, such as those encountered when a vehicle is in motion.

In addition, since the bottom surface of the case 15 is flat, it may lack both compression and bending stability against external impact loads, as well as stability for even flow of the electrolyte.

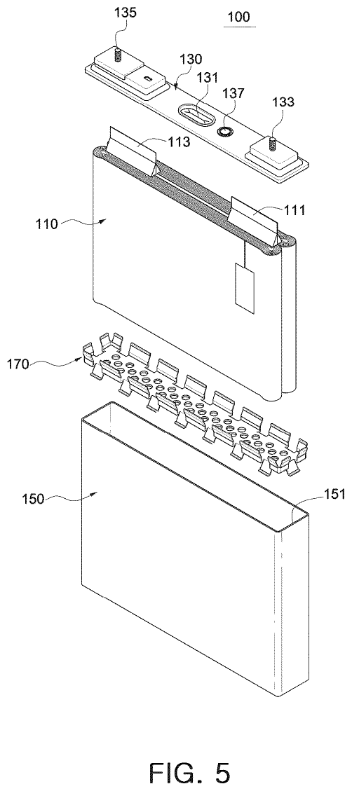

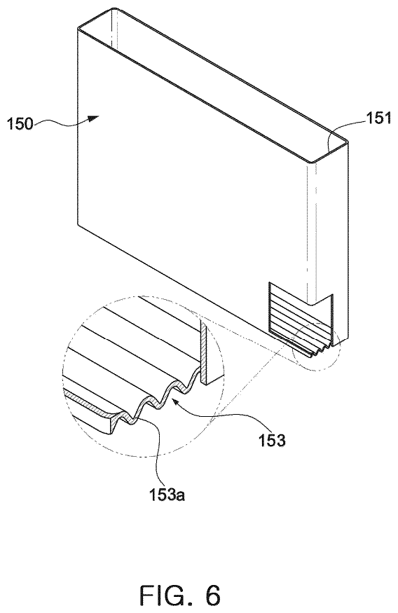

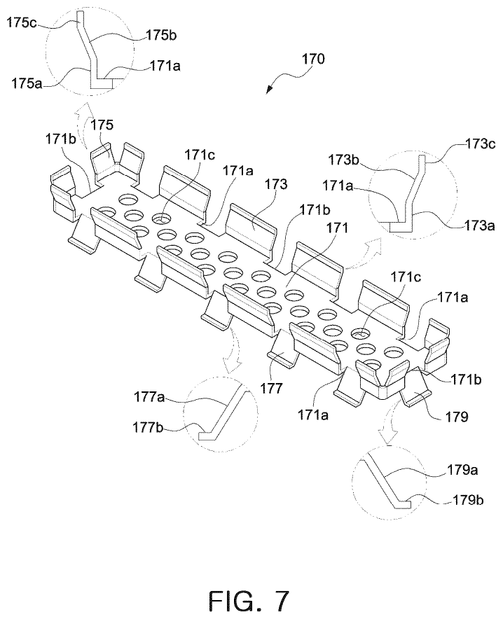

A secondary battery 100 based on an embodiment will be described with reference to FIGS. 5 to 7. FIG. 5 is an exploded perspective view of a secondary battery based on an embodiment, FIG. 6 is a partially enlarged view of a battery case of FIG. 5, and FIG. 7 is an enlarged perspective view of an elastic support of FIG. 5.

As illustrated in FIGS. 5 to 7, the secondary battery 100 based on an embodiment may include an electrode assembly 110, a cap plate 130, a battery case 150, and an elastic support 170.

Although not illustrated, the electrode assembly 110 may include a positive electrode, a negative electrode, and a separator. The electrode assembly 110 may be formed as a structure in which the positive electrode, the negative electrode, and the separator are wound around a longitudinal or transverse axis, forming a “jelly roll,” but other configurations are also possible.

The positive electrode includes a positive electrode current collector and a positive electrode active material, the positive electrode current collector includes aluminum, an aluminum alloy, etc., and the positive electrode active material may include lithium cobalt oxide, lithium manganese oxide, lithium nickel oxide, lithium iron phosphate, etc.

A positive electrode active material may be applied to a portion of a surface of the positive electrode current collector, and the remaining portion of the surface without the positive electrode active material may serve as a positive electrode tab 111. In some implementations, a plurality of positive electrode tabs 111 may be provided, and some or all of the plurality of positive electrode tabs 111 may be bonded together.

The negative electrode may include a negative electrode current collector and a negative electrode active material, the negative electrode current collector may include copper, a copper alloy, nickel, a nickel alloy, etc., and the negative electrode active material may include carbon, silicon, etc.

A negative electrode active material may be applied to a portion of the surface of the negative electrode current collector, and the remaining portion of the negative electrode current collector without the negative electrode active material may serve as a negative electrode tab 113. In some implementations, a plurality of negative electrode tabs 113 may be provided, and some or all of the plurality of negative electrode tabs 113 may be bonded together.

The separator may be located between the positive electrode and the negative electrode to prevent direct physical contact between the positive electrode and the negative electrode while allowing ions to migrate through it. and For example, the separator may provide a passage for the migration of ions.

In addition, the separator may include a polymer material, such as polyethylene or polypropylene. The separator may include dry and wet separators and may include a coating layer, such as a ceramic coating layer.

A vent 131 may be provided in the center of the cap plate 130, and a positive electrode terminal 133 and a negative electrode terminal 135 may be located on both sides, respectively. The cap plate 130 may include an electrolyte inlet 137 formed between the vent 131 and the positive electrode terminal 133. In some implementations, the positions of the positive electrode terminal 133 and the negative electrode terminal 135 and the positions of the vent 131 and the electrolyte inlet 137 may be adjusted as needed.

The vent 131 is configured to open in response to internal pressure within the battery case 150, allowing excess internal pressure to be released externally from the battery case 150 to help stabilize the internal components of the battery case 150.

The positive electrode terminal 133 is positioned to be electrically connected to the positive electrode tab 111 of the electrode assembly 110, and the negative electrode terminal 135 is positioned to be electrically connected to the negative electrode tab 113 of the electrode assembly 110. When the positions of the positive electrode terminal 133 and the negative electrode terminal 135 are adjusted, the positions of the positive electrode tab 111 and the negative electrode tab 113 are also adjusted accordingly.

The electrolyte inlet 137 is used to inject an electrolyte into the internal space of the battery case 150. In an embodiment, the electrolyte inlet 137 is located to be adjacent to the vent 131, but the position of the electrolyte inlet 137 may vary. In addition, the electrolyte inlet 137 may be securely sealed after injection of the electrolyte, a chemical reaction process, etc. The electrolyte inlet 137 may be sealed by press-fitting a ball-shaped sealing member formed of a polymer resin.

The battery case 150 provides an internal space to accommodate the electrode assembly 110 and the electrolyte, and includes the opening 151 at the top of the battery case 150. The electrolyte may be formed of an organic solvent including a lithium salt, and for example, the lithium salt may include lithium hexafluorophosphate (LiPF₆), lithium tetrafluoroborate (LiBF₄), etc. in a liquid or gel state. The organic solvent may include a cyclic carbonate, such as ethylene carbonate (EC) or propylene carbonate (PC), a linear carbonate, such as diethyl carbonate (DEC), dimethyl carbonate (DMC), ethyl methyl carbonate (EMC), etc.

The opening 151 of the battery case 150 may be completely sealed by the cap plate 130. To this end, the opening 151 of the battery case 150 and the cap plate 130 may be formed to match in shape and size, and, for example, the cap plate 130 may be welded to the top of the battery case 150 by ultrasonic welding, laser welding, etc. for a complete closure or seal.

The battery case 150 may have an uneven portion 153 formed on the bottom surface to help the electrolyte flow evenly or smoothly.

The uneven portion 153 is formed to have a concavo-convex cross-section as shown in an enlarged view of FIG. 6.

In addition, the uneven portion 153 may increase the transverse rigidity of the bottom surface of the battery case 150, thereby significantly increasing the compression or bending stability of the battery case 150 against external impact loads, etc.

A concave portion 153a may serve as a path so that the electrolyte, injected into the battery case 150 through the electrolyte inlet 137 formed on the cap plate 130, may be evenly distributed in the transverse direction of the bottom surface, as it begins to rise and accumulate on the bottom surface.

In addition, the concave portion 153a may serve as a space for debris (e.g., arc debris), generated from the electrode assembly 110 during repeated charging and discharging, to accumulate without coming into contact with the bottom surface of the electrode assembly 110, when falling downward.

The elastic support 170 may be mounted on the inner bottom of the battery case 150 and elastically supports the electrode assembly 110 in a vertical direction, and as shown in an enlarged view of FIG. 7, the elastic support 170 may include a bottom plate 171, a longer upward side elastic support piece 173, a shorter upward side elastic support piece 175, a longer downward side elastic support piece 177, and a shorter downward side elastic support piece 179.

The bottom plate 171 may have a rectangular shape like the bottom surface of the battery case 150, and the size of the bottom plate 171 may be formed to be smaller than the bottom surface of the battery case 150.

In some implementations, rectangular protrusions 171a and recesses 171b are alternately and repeatedly arranged along two opposing longer sides and two opposing shorter sides of the bottom plate 171, such that the rectangular protrusions 171a and recesses 171b on the opposing longer sides face each other and the rectangular protrusions 171a and recesses 171b on the opposing shorter sides face each other. The bottom plate 171 may be formed with inlet holes 171c through which the electrolyte, accumulating on the bottom surface, flows into the bottom surface of the electrode assembly 110. The inlet holes 171c may be formed in a circular shape as shown in the drawings or may be formed in a circular shape, or a polygonal shape such as a square or rectangle.

The longer upward side elastic support piece 173 may be formed upward and integrally connected with protrusions 171a formed on the two longer sides of the bottom plate 171 facing each other. The longer upward side elastic support piece 173 may include a close contact portion 173a vertically connected to the protrusions 171a, an extension portion 173b inclined upward from and connected to the close contact portion 173a, and a finishing portion 173c vertically connected from the extension portion 173b.

The shorter upward side elastic support piece 175 may be formed upward and integrally connected with the protrusions 171a formed on the two shorter sides of the bottom plate 171 facing each other. The shorter upward side elastic support piece 175 may include a close contact portion 175a vertically connected to the protrusions 171a, an extension portion 175b inclined upward from (and connected to) the close contact portion 175a, and a finishing portion 175c vertically connected from the extension portion 175b.

The longer downward side elastic support piece 177 may be formed downward and integrally connected with the recesses 171b formed on the two longer sides of the bottom plate 171 facing each other. The longer downward side elastic support piece 177 may include an extension portion 177a inclined downward from (and connected to) the recesses 171b and a support portion 177b horizontally connected to the extension portion 177a.

The shorter downward side elastic support piece 179 may be formed downward and integrally connected with the recesses 171b formed on two shorter sides of the bottom plate 171 facing each other. The shorter downward side elastic support piece 179 may include an extension portion 179a inclined downward from (and connected to) the recesses 171b and a support portion 179b horizontally connected to the extension portion 179a.

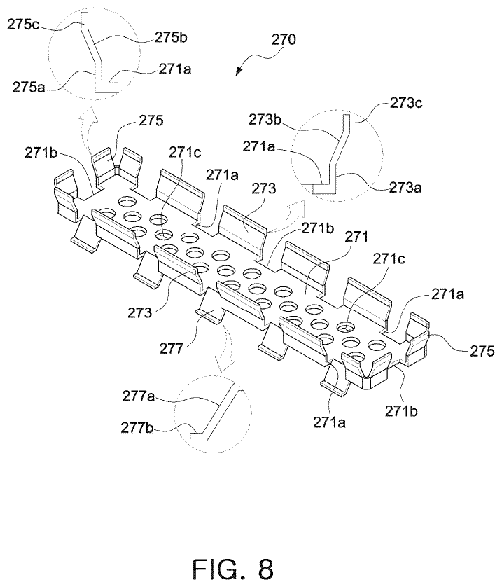

Next, an elastic support based on another embodiment will be described with reference to FIG. 8.

The elastic support 270 based on another embodiment may be mounted on the inner bottom of the battery case 150 to elastically support the electrode assembly 110 in the vertical direction and may include a bottom plate 271, a longer upward side elastic support piece 273, a shorter upward side elastic support piece 275, and a longer downward side elastic support piece 277.

The bottom plate 271 may have a rectangular shape like the bottom surface of the battery case 150, and the size of the bottom plate 271 may be formed to be smaller than the bottom surface of the battery case 150.

In the bottom plate 271, rectangular protrusions 271a and recesses 271b are repeatedly formed to be spaced from each other alternately in a facing manner on two longer sides facing each other and two shorter sides facing each other. The bottom plate 271 may be formed with inlet holes 271c through which the electrolyte, accumulating on the bottom surface, flows into the bottom surface of the electrode assembly 110. The inlet holes 271c may be formed in a circular shape as shown in the drawing or may be formed in a circular shape, or a polygonal shape such as a square or rectangle.

The longer upward side elastic support piece 273 may be formed upward and integrally connected with protrusions 271a formed on the two longer sides of the bottom plate 271 facing each other. The longer upward side elastic support piece 273 may include a close contact portion 273a vertically connected to the protrusions 271a, an extension portion 273b inclined upward from (and connected to) the close contact portion 273a, and a finishing portion 273c vertically connected from the extension portion 273b.

The shorter upward side elastic support piece 275 may be formed upward and integrally connected with the protrusions 271a formed on the two shorter sides of the bottom plate 271 facing each other. The shorter upward side elastic support piece 275 may include a close contact portion 275a vertically connected to the protrusions 271a, an extension portion 275b inclined upward from (and connected to) the close contact portion 275a, and a finishing portion 275c vertically connected from the extension portion 275b.

The longer downward side elastic support piece 277 may be formed downward and integrally connected with the recesses 271b formed on the two longer sides of the bottom plate 271 facing each other. The longer downward side elastic support piece 277 may include an extension portion 277a inclined downward from (and connected to) the recesses 271b and a support portion 277b horizontally connected to the extension portion 277a.

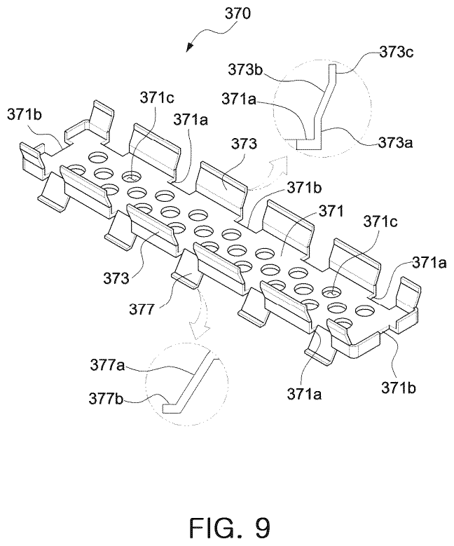

An elastic support based on another embodiment will be described with reference to FIG. 9.

The elastic support 370 based on another embodiment may be mounted on the inner bottom of the battery case 150 to elastically support the electrode assembly 110 in the vertical direction and may include a bottom plate 371, a longer upward side elastic support piece 373, and a longer downward side elastic support piece 377.

In the bottom plate 371, rectangular protrusions 371a and recesses 371b are repeatedly formed to be spaced from each other alternately in a facing manner on two longer sides facing each other and two shorter sides facing each other. The bottom plate 371 may be formed with inlet holes 371c through which the electrolyte, accumulating on the bottom surface, flows into the bottom surface of the electrode assembly 110. The inlet holes 371c may be formed in a circular shape as shown in the drawing or may be formed in a circular shape, or a polygonal shape such as a square or rectangle.

The longer upward side elastic support piece 373 may be formed upward and integrally connected with protrusions 371a formed on the two longer sides of the bottom plate 371 facing each other. The longer upward side elastic support piece 373 may include a close contact portion 373a vertically connected to the protrusions 371a, an extension portion 373b inclined upward from (and connected to) the close contact portion 373a, and a finishing portion 373c vertically connected from the extension portion 373b.

The longer downward side elastic support piece 377 may be formed downward and integrally connected with the recesses 371b formed on the two longer sides of the bottom plate 371 facing each other. The longer downward side elastic support piece 377 may include an extension portion 377a inclined downward from (and connected to) the recesses 371b and a support portion 377b horizontally connected to the extension portion 377a.

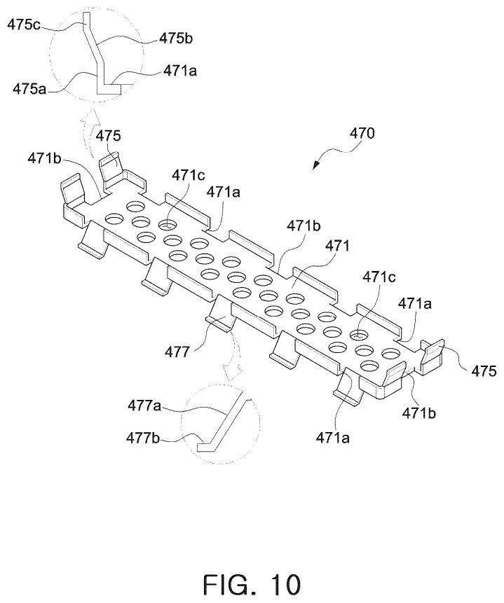

An elastic support based on another embodiment will be described with reference to FIG. 10.

An elastic support 470 based on another embodiment may be mounted on the inner bottom of the battery case 150 to elastically support the electrode assembly 110 in the vertical direction and may include a bottom plate 471, a shorter upward side elastic support piece 475, and a longer downward side elastic support piece 477.

The bottom plate 471 may have a rectangular shape like the bottom surface of the battery case 150, and the size of the bottom plate 471 may be formed to be smaller than the bottom surface of the battery case 150.

In the bottom plate 471, rectangular protrusions 471a and recesses 471b are repeatedly formed to be spaced from each other alternately in a facing manner on two longer sides facing each other and two shorter sides facing each other. The bottom plate 471 may be formed with inlet holes 471c through which the electrolyte, accumulating on the bottom surface, flows into the bottom surface of the electrode assembly 110. The inlet holes 471c may be formed in a circular shape as shown in the drawing or may be formed in a circular shape, or a polygonal shape such as a square or rectangle.

The shorter upward side elastic support piece 475 may be formed upward and integrally connected with protrusions 471a formed on the two shorter sides of the bottom plate 471 facing each other. The shorter upward side elastic support piece 475 may include a close contact portion 475a vertically connected to the protrusions 471a, an extension portion 475b inclined upward from (and connected to) the close contact portion 473a, and a finishing portion 475c vertically connected from the extension portion 475b.

The longer downward side elastic support piece 477 may be formed downward and integrally connected with the recesses 471b formed on two longer sides of the bottom plate 471 facing each other. The longer downward side elastic support piece 477 may include an extension portion 477a inclined downward from (and connected to) the recesses 471b and a support portion 477b horizontally connected to the extension portion 477a.

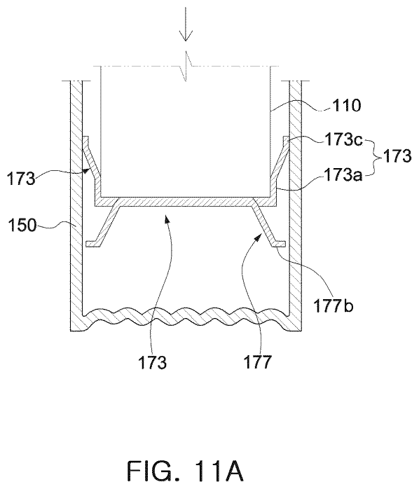

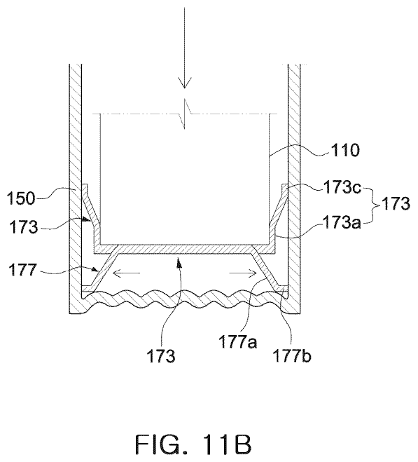

Next, the operation between the battery case 150, the electrode assembly 110, and the elastic support 170 of FIG. 5 will be described with reference to FIGS. 11A and 11B. FIG. 11A illustrates a state in which the electrode assembly 110, mounted on the elastic support 170, is inserted into the battery case 150, and FIG. 11B illustrates a state in which the insertion is completed. Although the description is omitted, the elastic supports 270, 370, and 470 based on some embodiments of the elastic support may also operate similarly to that described below.

As shown in FIG. 11A, when the electrode assembly 110, in a state of being mounted on the elastic support 170, is inserted into the battery case 150 in the direction of the short arrow, the close contact portion 173a of the longer upward side elastic support piece 173 is in close contact with a portion of a lower end of the electrode assembly 110 and the finishing portion 173c is in close contact with the inner wall of the battery case 150. However, the support portion 177b of the longer downward side elastic support piece 177 is not in contact with the inner wall of the battery case 150.

Meanwhile, as shown in FIG. 11B, when the electrode assembly 110, in a state of being mounted in the elastic support 170, is completely inserted into the battery case 150 in the direction of the long arrow, the close contact portion 173a of the longer upward side elastic support piece 173 is in close contact with a portion of the lower end of the electrode assembly 110 and the finishing portion 173c is in close contact with the inner wall of the battery case 150. The support portion 177b of the longer downward side elastic support piece 177 is also in contact with the inner wall of the battery case 150.

Here, the extension portion 177a is elastically spread sideways in the direction of the horizontal arrow by the force pressing the electrode assembly 110, so that the support portion 177b connected to the end of the extension portion 177a may contact the inner wall of the battery case 150.

Since the lower circumference of the electrode assembly is surrounded by the bottom elastic support, the electrode assembly based on some embodiments of the disclosed technology may significantly improve the stability against external impact loads when a vehicle that includes a secondary battery with the electrode assembly is in motion.

In addition, since an uneven portion is formed on the bottom surface of the battery case based on some embodiments of the disclosed technology, the compression and bending stability of the battery case against external impact loads may be significantly improved.

In addition, since the uneven portion is formed on the bottom surface of the battery case based on some embodiments of the disclosed technology, the stability for the even flow of the electrolyte accumulating on the bottom surface may be significantly improved.

The disclosed technology can be implemented in rechargeable secondary batteries that are widely used in battery-powered devices or systems, including, e.g., digital cameras, mobile phones, notebook computers, hybrid vehicles, electric vehicles, uninterruptible power supplies, battery storage power stations, and others including battery power storage for solar panels, wind power generators and other green tech power generators. Specifically, the disclosed technology can be implemented in some embodiments to provide improved electrochemical devices such as a battery used in various power sources and power supplies, thereby mitigating climate changes in connection with uses of power sources and power supplies. Lithium secondary batteries based on the disclosed technology can be used to address various adverse effects such as air pollution and greenhouse emissions by powering electric vehicles (EVs) as alternatives to vehicles using fossil fuel-based engines and by providing battery-based energy storage systems (ESSs) to store renewable energy such as solar power and wind power.

Only specific examples of implementations of certain embodiments are described. Variations, improvements and enhancements of the disclosed embodiments and other embodiments may be made based on the disclosure of this patent document.

What is claimed is:

1. A secondary battery comprising:
an electrode assembly including a positive electrode, a negative electrode, and a separator configured to separate the positive electrode and the negative electrode from each other;
a battery case including: a space structured to accommodate the electrode assembly; and at least one opening;
a cap plate coupled to the battery case to close the at least one opening and including an electrolyte inlet configured to inject an electrolyte; and
an elastic support disposed at least partially in close contact with a lower edge of the electrode assembly and mounted on an inner bottom surface of the battery case to elastically support the electrode assembly in a vertical direction.

2. The secondary battery of claim 1, wherein the battery case includes an uneven portion disposed on the inner bottom surface of the battery case to increase transverse rigidity of the inner bottom surface and allow an even flow of the electrolyte.

3. The secondary battery of claim 2, wherein the uneven portion includes a concave portion configured to evenly distribute the electrolyte in a transverse direction of the inner bottom surface, when the electrolyte starts to rise on the inner bottom surface.

4. The secondary battery of claim 3, wherein the concave portion is configured to allow debris generated from the electrode assembly to accumulate without coming into contact with the inner bottom surface of the electrode assembly, when the debris falls downward.

5. The secondary battery of claim 1, wherein the elastic support includes a bottom plate, and
wherein the bottom plate includes:
protrusions and recesses alternately and repeatedly arranged along two opposing longer sides and two opposing shorter sides of the bottom plate, such that the protrusions and recesses on the opposing longer sides face each other and the protrusions and recesses on the opposing shorter sides face each other; and
inlet holes configured to allow electrolyte flow.

6. The secondary battery of claim 5, wherein the inlet holes are formed in a circular shape or a polygonal shape.

7. The secondary battery of claim 5, wherein the elastic support further includes a longer upward side elastic support piece extending upward and integrally connected with the protrusions formed on the two opposing longer sides of the bottom plate.

8. The secondary battery of claim 7, wherein the longer upward side elastic support piece includes a close contact portion vertically connected to the protrusions, an extension portion inclined upward from the close contact portion, and a finishing portion vertically connected to the extension portion.

9. The secondary battery of claim 5, wherein the elastic support further includes a shorter upward side elastic support piece formed upward and integrally connected with the protrusions formed on the two opposing shorter sides of the bottom plate.

10. The secondary battery of claim 9, wherein the shorter upward side elastic support piece includes a close contact portion vertically connected to the protrusions, an extension portion inclined upward from the close contact portion, and a finishing portion vertically connected to the extension portion.

11. The secondary battery of claim 5, wherein the elastic support further includes a longer downward side elastic support piece formed downward and integrally connected with recesses formed on the two opposing longer sides of the bottom plate.

12. The secondary battery of claim 11, wherein the longer downward side elastic support piece includes an extension portion inclined downward from the recesses and a support portion connected horizontally to the extension portion.

13. The secondary battery of claim 5, wherein the elastic support further includes a shorter downward side elastic support piece formed downward and integrally connected with recesses formed on the two opposing shorter sides of the bottom plate.

14. The secondary battery of claim 13, wherein the shorter downward side elastic support piece includes an extension portion inclined downward from the recesses and a support portion connected horizontally to the extension portion.
